(19) United States
(12) Patent Application Publication
(10) Pub. No.: US 2026/0333431 A1
(43) Pub. Date: Oct. 22, 2026

(54) COOPERATIVE WIRELESS COMMUNICATION BETWEEN A CO-CHANNEL COLLOCATED SET OF ACCESS POINTS

(71) Applicant: QUALCOMM Incorporated, San Diego, CA (US)

(72) Inventors: Abhishek Pramod PATIL, San Diego, CA (US); Gaurang NAIK, San Diego, CA (US); Sanket Sanjay KALAMKAR, San Diego, CA (US); Alfred ASTERJADHI, San Diego, CA (US); George CHERIAN, San Diego, CA (US); Giovanni CHISCI, San Diego, CA (US); Sherief HELWA, San Diego, CA (US); Sai Yiu Duncan HO, San Diego, CA (US)

(21) Appl. No.: 19/183,574

(22) Filed: Apr. 18, 2025

(51) Int. Cl. H04W 74/0816; H04W 8/22; H04W 74/08

(52) U.S. Cl. CPC H04W 74/0816; H04W 8/22; H04W 74/0875

(57) ABSTRACT

This disclosure provides methods, components, devices and systems for cooperative wireless communication between a co-channel collocated set of access points (APs). In some examples, an AP of the co-channel collocated set of APs may transmit configuration information pertaining to the co-channel collocated set of APs. The co-channel collocated set of APs may include a coordinator AP that facilitates cooperative wireless communication performed by the co-channel collocated set of APs. For example, the coordinator AP may facilitate the cooperative wireless communication by obtaining channel access on behalf of the co-channel collocated set of APs and/or by serving a station (STA) associated with another AP of the co-channel collocated set of APs. The configuration information may indicate a size of the co-channel collocated set of APs and/or an identifier of the coordinator AP.

### TECHNICAL FIELD

This disclosure relates generally to wireless communication and, more specifically, to cooperative wireless communication between a co-channel collocated set of access points (APs).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

An AP and an associated set of STAs 104 may be referred to as a basic service set (BSS), with the AP managing the BSS (such as scheduling, soliciting, or otherwise coordinating communication within the BSS). Communication between two wireless communication devices within a same BSS may be referred to as in-BSS communication. A BSS identifier (BSSID) may identify a specific BSS. In some wireless communication networks, two or more APs may belong to a cohosted set of APs or a multiple BSSID set, with each AP of the set managing a respective BSS. APs within a cohosted set of APs or a multiple BSSID set may be within a same physical device and communicate via a same channel.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by or at a first access point (AP). The method may include transmitting one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs, and communicating with one or more wireless devices in accordance with the configuration of the co-channel collocated set of APs.

Another innovative aspect of the subject matter described in this disclosure can be implemented in a first AP. The first AP may include a processing system that includes processor circuitry and memory circuitry that stores code. The processing system may be configured to cause the first AP to transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs, and communicate with one or more wireless devices in accordance with the configuration of the co-channel collocated set of APs.

Another innovative aspect of the subject matter described in this disclosure can be implemented in a first AP. The first AP may include means for transmitting one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs, and means for communicating with one or more wireless devices in accordance with the configuration of the co-channel collocated set of APs.

Another innovative aspect of the subject matter described in this disclosure can be implemented in a non-transitory computer-readable medium storing code for wireless communication by a first AP. The code may include instructions executable by one or more processors to (cause the first AP to) transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs, and communicate with one or more wireless devices in accordance with the configuration of the co-channel collocated set of APs.

In some examples of the method, first APs, and non-transitory computer-readable medium described herein, the cooperative wireless communication performed by the co-channel collocated set of APs includes transmission opportunity (TXOP) sharing between the co-channel collocated set of APs, the coordinator AP facilitates the cooperative wireless communication performed by the co-channel collocated set of APs by obtaining or releasing a TXOP on behalf of the co-channel collocated set of APs, and the first AP communicates with the one or more wireless devices within the TXOP obtained by the coordinator AP.

Some examples of the method, first APs, and non-transitory computer-readable medium described herein may further include operations, features, means, or instructions for obtaining the TXOP as a result of performing a channel access procedure or as a result of negotiating a multi-AP coordination procedure and allocating one or more portions of the TXOP to one or more other APs of the co-channel collocated set of APs in accordance with obtaining the TXOP, where the cooperative wireless communication performed by the co-channel collocated set of APs includes allocating the one or more portions of the TXOP to the one or more other APs of the co-channel collocated set of APs.

In some examples of the method, first APs, and non-transitory computer-readable medium described herein, communicating with the one or more wireless devices may include operations, features, means, or instructions for transmitting, within the TXOP, a packet that includes an indication of a network allocation vector (NAV), where a duration of the NAV may be based on a sharing of the TXOP between two or more APs of the co-channel collocated set of APs.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example PPDU usable for communication between a wireless access point (AP) and one or more wireless stations (STAs).

FIG. 3 shows an example of a signaling diagram that supports cooperative wireless communication between a co-channel collocated set of APs.

FIG. 4 shows an example of a communication timeline that supports cooperative wireless communication between a co-channel collocated set of APs.

FIG. 5 shows an example of a process flow that supports cooperative wireless communication between a co-channel collocated set of APs.

FIG. 6 shows a block diagram of an example wireless communication device that supports cooperative wireless communication between a co-channel collocated set of APs.

FIG. 7-9 show flowcharts illustrating example processes performable by or at a first AP that supports cooperative wireless communication between a co-channel collocated set of APs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, two or more APs may belong to a co-channel collocated set of APs. A co-channel collocated set of APs may be or refer to a cohosted set of APs, a multiple basic service set (BSS) identifier (BSSID) set, or two or more multiple BSSID sets (which may be referred to or otherwise understood as multiple multiple BSSID sets, or multiple “MBSSID” sets). In some networks, APs within a co-channel collocated set of APs may support cooperative wireless communication. For example, a first AP of a co-channel collocated set of APs may pass a transmission opportunity (TXOP) to a second AP of the co-channel collocated set of APs. Additionally, or alternatively, the first AP may communicate with (such as serve) a wireless station (STA) associated with (such as having a wireless connection with) the second AP. In deployments in which the APs of the co-channel collocated set of APs are within a same physical device, the first AP and the second AP may coordinate via internal signaling (such as via non-over-the-air communication), which may cause or lead to compatibility issues between APs of the co-channel collocated set of APs and one or more wireless communication devices in the neighborhood (such as nearby). The one or more other wireless communication devices may include non-collocated APs, non-AP STAs (such as previous generation STAs or STAs having less than a threshold capability) served by the co-channel collocated set of APs, and/or other non-AP STAs. The other non-AP STAs may attempt to discover one or more APs of the co-channel collocated set of APs, or the other non-AP STAs may be served by a non-collocated AP in the neighborhood. The compatibility issues caused by the internal signaling between the co-channel collocated set of APs may impact any of such wireless communication devices, including the non-AP STAs served by the non-collocated AP. For example, the non-AP STAs may incorrectly set a network allocation vector (NAV) or may incorrectly determine a TXOP owner. Without being aware of the coordination between the APs of the co-channel collocated set of APs and without network-defined rules (such as expectations) that define the coordination between the APs of the co-channel collocated set of APs, various wireless communication devices within a network may interpret communication and/or operations by the co-channel collocated set of APs as anomalous. By way of further example, without network-defined rules that define the coordination between the APs of the co-channel collocated set of APs, some communication and/or operations by the co-channel collocated set of APs may violate (or may be interpreted as violating) one or more expectations relating to channel access and/or TXOP sharing, among other defined network operations and/or procedures. For example, a wireless communication device may incorrectly set a NAV for a packet transmission such that the NAV contradicts one or more expectations related to channel access and/or TXOP sharing, which may cause unwanted ramifications including, for example, unresponsive non-collocated APs and/or non-AP STAs. In such examples, another wireless communication device in the neighborhood may interpret the NAV as violating one or more network defined rules for coordination between APs. As a result, the other wireless communication device may categorize or otherwise label the NAV-setting wireless communication device as distrustful, which may hinder future coordination.

Various aspects relate generally to cooperative wireless communication performed by a co-channel collocated set of APs. Some aspects more specifically relate to one or more rule-based and/or signaling-based mechanisms that define coordination between APs of the co-channel collocated set of APs in a manner that is compatible with operation and expectations of one or more non-collocated APs. In some examples, a first AP of the co-channel collocated set of APs may transmit configuration information pertaining to the co-channel collocated set of APs. The configuration information may enable the co-channel collocated set of APs to perform cooperative wireless communication without other (non-collocated) wireless communication devices identifying (such as determining, detecting, or interpreting) the cooperative wireless communication as anomalous. For example, the configuration information may indicate a size of the co-channel collocated set of APs, an identifier (such as a medium access control (MAC) address or an index (a numeric value assigned within the set to each AP)) of a coordinator AP of the co-channel collocated set of APs, and/or a configuration for multiple user-enhanced distributed channel access (MU-EDCA) operation by APs of the co-channel collocated set of APs. In some aspects, the coordinator AP may facilitate the cooperative wireless communication performed by the co-channel collocated set of APs. The coordinator AP may facilitate the cooperative wireless communication by performing channel access operations on behalf of one or more other APs within the co-channel collocated set of APs and/or by serving one or more STAs in any BSS within the co-channel collocated set of APs. In some examples, the configuration information may indicate the coordinator AP. Additionally, or alternatively, the coordinator AP may be any AP of the co-channel collocated set of APs that obtains a TXOP. The coordinator AP may lead (such as manage or organize) TXOP sharing with other APs of the co-channel collocated set of APs. In some examples, the coordinator AP may negotiate one or more parameters for one or more multi-access point coordination (MAPC) schemes for one or more other APs of the co-channel collocated set of APs. The one or more MAPC schemes may include coordinated time domain multiple access (C-TDMA), coordinated beam forming (CBF), coordinated spatial reuse (CSR), or coordinated-restricted target wake time (C-RTWT). For example, in C-TDMA, the coordinator AP may obtain the TXOP by indicating traffic utilization for the co-channel collocated set of APs. In some examples, within a TXOP, the coordinator AP may transmit a packet that includes a NAV that exclusively protects frame exchanges with the coordinator AP, enabling other APs of the co-channel collocated set of APs to serve associated STAs within the TXOP (with such other APs of the co-channel collocated set of APs having prioritized channel access within the TXOP).

Particular aspects of the subject matter described in this disclosure can be implemented to realize one or more of the following potential advantages. In some implementations, by indicating configuration information that pertains to a co-channel collocated set of APs, the described techniques can be used to enable cooperative wireless communication performed by the co-channel collocated set of APs by, for example, identifying a coordinator AP of the co-channel collocated set of APs. The cooperative wireless communication performed by the co-channel collocated set of APs may increase a reliability of communication by being in accordance with defined network operations and/or procedures. Moreover, the cooperative wireless communication performed by the co-channel collocated set of APs may support increased network capacity, higher data rates, and greater spectral efficiency by enabling greater coordination between APs of the co-channel collocated set of APs and being in accordance with defined network operations and/or procedures. For example, TXOP sharing facilitated by the coordinator AP may increase communication efficiency and increase an amount of communication resources available to other APs of the co-channel collocated set of APs. Additionally, or alternatively, the coordinator AP communicating with a STA associated with (such as having a wireless connection with) another AP of the co-channel collocated set of APs may increase communication efficiency and communication reliability at the STA by enabling lower latency and more dynamic frame exchanges. Additionally, or alternatively, the negotiations performed by the coordinator AP on behalf of the co-channel collocated set of APs may decrease signaling overhead for the co-channel collocated set of APs, which may result in more communication resources being available for data transmissions and reduced power consumption by way of less signaling or more efficient signaling. Further, in accordance with APs of the co-channel collocated set of APs coordinating via internal signaling (such as via “silent” TXOP sharing), the overall network may experience less over-the-air signaling transmitted by the co-channel collocated set of APs. Such reduced over-the-air signaling may free up additional over-the-air frames in a medium for useful transmissions which may increase data rate (such as improving an overall system efficiency). Moreover, the co-channel collocated set of APs may maintain compatibility with operation and expectations of non-collocated APs in accordance with, for example, participating in MAPC schemes via the coordinator AP of the co-channel collocated set of APs. In other words, by participating in an MAPC scheme with non-collocated APs via the coordinator AP, the co-channel collocated set of APs may limit over-the-air signaling pertaining to the MAPC scheme (including TXOP sharing and/or TXOP returning frames, among other examples) to the coordinator AP, which may align with the expectations of the non-collocated APs. Such compatibility may support greater network-wide coordination and greater communication efficiency across the various APs within the network, including by enabling the full co-channel collocated set of APs to experience the greater spectral efficiency provided by the MAPC scheme without appearing as unfriendly or uncooperative devices within the network.

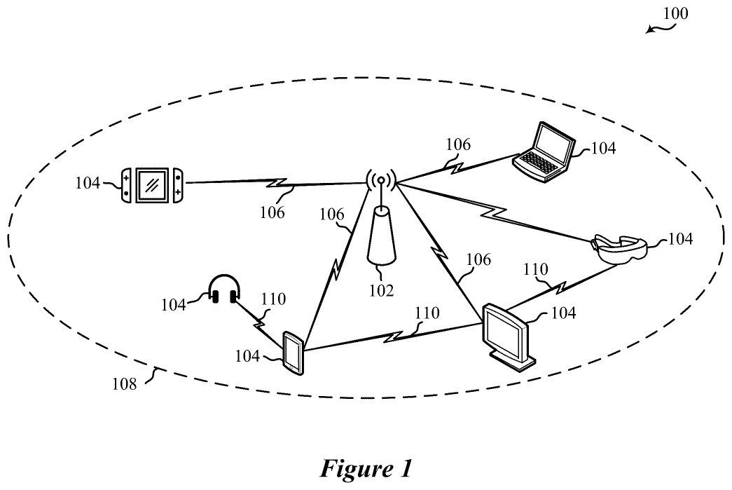

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a BSSID, which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands. In some examples, multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz 71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Any transmission by an AP 102 or a STA 104 within a BSS must involve transmission on the primary 20 MHz channel. As such, in some systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, in examples in which a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communication spanning operating bandwidths of 20 MHz, 40 MHz, 80 MHz, 160 MHz, 240 MHz, and 320 MHz while a UHR system may enable communication spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some examples, a co-channel collocated set of APs 102 (such as a UHR collocated AP set) may support greater wireless resource utilization by enabling collocated APs 102 to share a TXOP and/or communicate with STAs 104 associated with other APs 102 in the co-channel collocated set of APs 102. The co-channel collocated set of APs 102 may support greater network coordination and efficiency. Various aspects generally relate to rule-based and/or signaling-based mechanisms that support configurations pertaining to cohosted and multiple BSSID sets (including multiple multiple BSSID sets), using a same BSS color for intra-BSS communication, NAV settings, a coordinator AP 102 for TXOP sharing and serving, and/or supporting backward compatibility while increasing network capacity. Various further aspects relate to rule-based and/or signaling-based mechanisms that support configurations pertaining to using different BSS colors for STAs 104 with less than a threshold capability (such as to maintain compatibility with previous or earlier generation STAs 104) and/or employing a coordinator AP 102 for channel access management. In accordance with one or more of such aspects, APs 102 of a co-channel collocated set of APs 102 may perform TXOP sharing with greater efficiency.

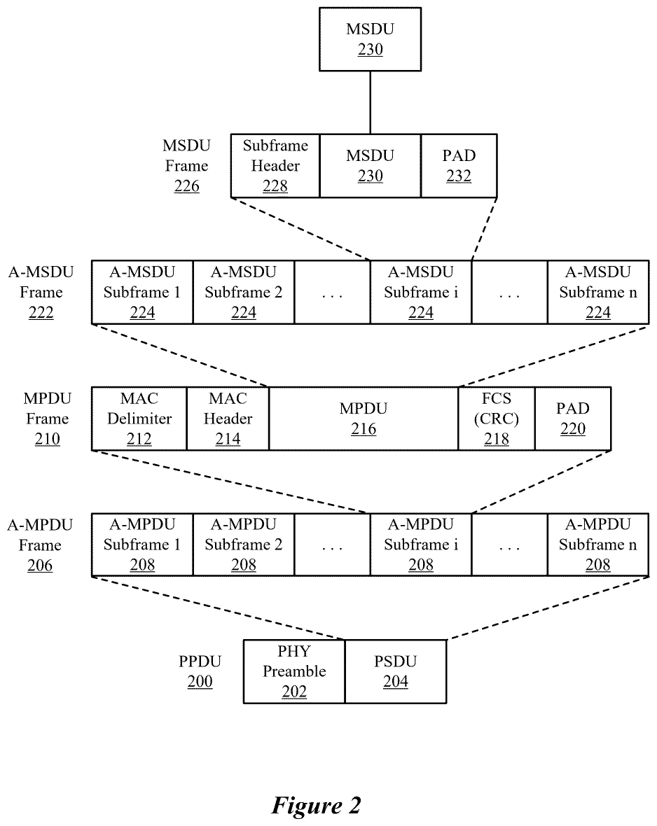

FIG. 2 shows a hierarchical format of an example PPDU usable for communication between a wireless AP and one or more wireless STAs. For example, the AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. For example, the MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some examples, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. For example, the MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, in examples in which the received signal strength of a detected preamble is above a threshold, the medium is considered busy. Physical carrier sensing also includes energy detection. Energy detection involves measuring the total energy the wireless communication device receives regardless of whether the received signal represents a valid frame. In examples in which the total energy detected is above a threshold, the medium is considered busy.

Virtual carrier sensing is accomplished via the use of a NAV, which effectively serves as a time duration that elapses before the wireless communication device may contend for access even in the absence of a detected symbol or even in examples in which the detected energy is below the relevant threshold. The NAV is reset each time a valid frame is received that is not addressed to the wireless communication device. In scenarios in which the NAV reaches 0, the wireless communication device performs the physical carrier sensing. In examples in which the channel remains idle for the appropriate IFS, the wireless communication device initiates a backoff timer, which represents a duration of time that the device senses the medium to be idle before it is permitted to transmit. In examples in which the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. On the other hand, in examples in which one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period or duration, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communication using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. In examples in which an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, in examples in which the BSS color associated with the wireless packet is the same as the BSS color of the AP 102 or STA 104, the AP 102 or STA 104 may use a first RSSI detection threshold in scenarios of performing a CCA on the wireless channel. However, in examples in which the BSS color associated with the wireless packet is different than the BSS color of the AP 102 or STA 104, the AP 102 or STA 104 may use a second RSSI detection threshold in lieu of using the first RSSI detection threshold in scenarios of performing the CCA on the wireless channel, the second RSSI detection threshold being greater than the first RSSI detection threshold. In this way, the criteria for winning contention are relaxed in scenarios in which interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communication with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods or durations associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to some CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or in scenarios in which the decoding error rates of the selected APs are relatively low (such as less than a threshold), the start times of the communication among the different BSSs may be synchronous. Conversely, in scenarios in which the signal strengths or levels of interference associated with the selected APs are relatively high (such as greater than the given value), or in scenarios in which the decoding error rates of the selected APs are relatively high (such as greater than the threshold), the start times may be offset from one another by a time period (such as a duration) associated with decoding the preamble of a wireless packet and determining, from the decoded preamble, whether the wireless packet is an intra-BSS packet or is an OBSS packet. For example, the time period (such as the duration) between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used in scenarios in which the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

In scenarios of performing beamforming, the transmitting beamforming array gain is logarithmically proportional to the ratio of N_{Tx} to N_{SS}. As such, it is generally desirable, within other constraints, to increase the number N_{Tx} of transmit antennas in scenarios of performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as in examples in which STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communication to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

A co-channel collocated set of APs 102 (such as a UHR collocated AP set) may support greater wireless resource utilization by enabling collocated APs 102 to share a TXOP and communicate with stations served by other APs in the co-channel collocated set. The co-channel collocated set of APs 102 may support greater network coordination and efficiency. Various mechanisms and/or rules support or pertain to configuring cohosted and multiple BSSID sets, using a same BSS color for intra-BSS, configuring a network allocation vector, leveraging a coordinator AP 102 for TXOP sharing and serving, and/or ensuring backward compatibility while increasing network capacity. Additionally, or alternatively, various mechanisms and/or rules include using different BSS colors for some STAs 104 (such as previous generation STAs 104 or STAs having less than a threshold capability) and/or employing a coordinator AP 102 for channel access management. For example, a set of multiple BSSID or co-hosted BSSID may perform TXOP sharing with increased efficiency and reducing over-the-air TXOP sharing transmissions.

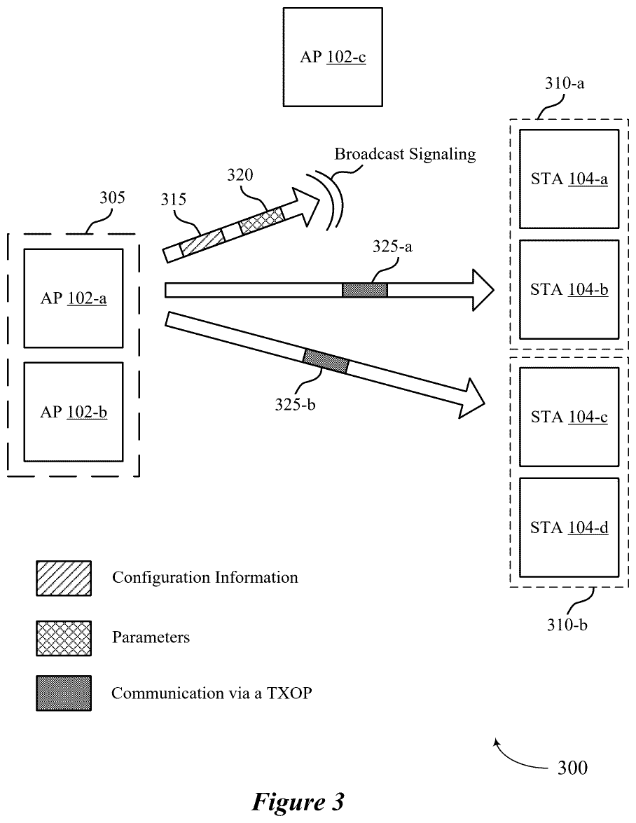

FIG. 3 shows an example of a signaling diagram 300 that supports cooperative wireless communication between a co-channel collocated set of APs 102. In some examples, signaling diagram 300 may implement aspects of wireless communication network 100. For example, an AP 102-a, an AP 102-b, and an AP 102-c may represent examples of an AP, such as the AP 102 described with reference to FIG. 1. A STA 104-a, an STA 104-b, an STA 104-c, and an STA 104-d may represent an example of an STA, such as the STA 104 described with reference to FIG. 1. A co-channel collocated set of APs 305 may include the AP 102-a and the AP 102-b. The co-channel collocated set of APs 305 may be an example of a collocated set of APs, a cohosted set of APs, or APs included in a set of multiple BSSID sets. The AP 102-a may serve a first set of STAs 310-a (such as including the STA 104-a and the STA 104-b) included within a BSS. The AP 102-b may serve a second set of STAs 310-b (such as including the STA 104-c and the STA 104-d) included within a BSS.

A collocated set of APs may include a set of two or more APs 102 in a same physical device. The two or more APs 102 may operate on a same channel (such as co-channel) or on different channels of frequency bands (such as 2.4 GHz and 6 GHz). For example, the co-channel collocated set of APs 305 may include the AP 102-a and the AP 102-b, which may be served by the same physical device and operate on a same channel. The co-channel collocated APs 102 (such as the AP 102-a and the AP 102-b) may form a multiple BSSID set or a cohosted BSSID set. In some examples, non-APs (such as non-AP STAs 104) may support multiple BSSID sets. In some examples, collocated APs 102 operating on 6 GHz may not form a cohosted BSSID set. In some examples, the co-channel collocated set of APs may be configured for a set of multiple BSSID sets (such as in 6 GHz). The set of multiple BSSID sets (such as multiple multiple BSSID sets) may decrease transmission of a beacon frame for each BSSID.

The APs 102 in a cohosted set of APs or a multiple BSSID set may advertise a same BSS color. For example, the AP 102-a and the AP 102-b may advertise the same BSS color. Transmissions within the BSS of the APs 102 may be treated as intra-BSS transmissions. However, in some networks, transmissions within a set of multiple BSSID set configuration may not be treated as intra-BSS transmissions. The STAs 104 may treat transmission from the APs 102 from a different multiple BSSID set as overlapping BSS (OBSS) transmissions.

In some examples, STAs 104 served by a non-transmitting BSSID (such as the AP 102-b) may (be operable or expected to) respond to a control frame sent by a transmitting BSSID (such as the AP 102-a). However, for cohosted BSSID set or across set of multiple BSSID sets, the STAs 104 served by the non-transmitting BSSID may not (be operable or expected to) respond to control frames sent by a transmitting BSSID.

The AP 102-a and the AP 102-b belonging to a co-channel collocated set of APs 305 may perform cooperative wireless communication. For example, the AP 102-a may share a TXOP with other APs 102 within the set of co-channel collocated set of APs 305. For example, the AP 102-a may share a TXOP with the AP 102-b. Sharing the TXOP may include performing CBF, C-TDMA, and/or spatial reuse. Additionally, or alternatively, the AP 102-a and the AP 102-b belonging to the co-channel collocated set of APs 305 may be able to serve STAs 104 served by other APs 102 within the set of co-channel collocated set of APs 305. For example, the AP 102-a may transmit data to and/or receive data from the STA 104-c, which may be served by the AP 102-b.

The AP 102-a may serve the STA 104-c in accordance with a capability of the STA 104-c. For example, the STA 104-c may transmit an indication of a capability of the STA 104-c to be served by another AP within the co-channel collocated set of APs 305 other than the serving AP (such as the AP 102-b). The AP 102-a may serve the STA 104-c based on the STA 104-c indicating a capability to be served by the AP 102-a.

The AP 102-a and the AP 102-b may communicate via internal signals to configure the cooperative wireless communication (such as collocated TXOP sharing and serving). Without receiving the coordination, the STA 104-c may identify the cooperative wireless communication as anomalous activity by the AP 102-a or the AP 102-b. The STA 104-c may drop a connection with the AP 102-a or the AP 102-b based on falsely identifying the cooperative wireless communication as anomalous activity.

In some examples, the AP 102-a and the AP 102-b may perform cooperative wireless communication with the set of STAs 310-a and the set of STAs 310-b in accordance with a configuration of the co-channel collocated set of APs 305. The configuration may enable support for various features, ensure backward compatibility, and provide smooth operation of the various features during the cooperative wireless communication. For example, the AP 102-a and the AP 102-b may perform cooperative wireless communication in examples in which some STAs 104 are configured for the cooperative wireless communication (such as UHR STAs 104) and some STAs 104 are not configured for cooperative wireless communication. For example, the STA 104-a may not be configured for the cooperative wireless communication, and the STA 104-b may be configured for the cooperative wireless communication.

The AP 102-a may transmit configuration information 315 indicating the configuration of the cooperative wireless communication. The configuration information may include an indication of a size of the co-channel collocated set of APs 305, a coordinating AP of the co-channel collocated set of APs, and/or a configuration for MU-EDCA. The AP 102-a may transmit one or more parameters 320 to facilitate the cooperative wireless communication. The AP 102-a may communicate with one or more wireless communication devices in accordance with the cooperative wireless communication. For example, the AP 102-a may communicate with an STA 104-a (such as an STA not configured for cooperative wireless communication), an STA 104-b (such as an STA configured for cooperative wireless communication), and an STA 104-c (such as an STA served by the AP 102-b within the co-channel collocated set of APs 305).

For example, the AP 102-a may transmit the configuration information 315 and/or the parameters 320 via one or more bits, fields, and/or elements of one or more frames. By way of further example, a Collocated AP Set Parameters element may carry (such as include) the configuration information 315 and/or the parameters 320. The configuration information 315 and/or the parameters 320 may indicate a value N that indicates a size of the co-channel collocated set of APs, a MAC address associated with a coordinator AP, and/or a configuration for MU-EDCA. The configuration information 315 and/or the parameters 320 may be advertised in a beacon frame or carried in probe frame, association frame, reassociation frame, and/or a link reconfiguration response frame. The co-channel collocated AP set parameter may be exchanged during MAPC discovery and negotiations.

The STA 104-a may identify the co-channel collocated set of APs 305. In examples in which the co-channel collocated set of APs 305 is a cohosted BSSID set, the STA 104-a may receive an indication of the co-channel collocated set of APs 305 (such as a high efficiency operations information element (IE) may include a value n for the cohosted set). For example, the AP 102-a may transmit an indication of the value n via the configuration information 315. The value n may indicate a quantity of APs within the co-channel collocated set of APs 305. For example, the quantity of APs within the co-channel collocated set of APs 305 may be 2ⁿ (such as n=2 for a set of 4 APs or n=3 for a set of 8 APs). The value of n may indicate any quantity APs (such as large n may work).

The co-channel collocated set of APs 305 may be an example of a set of multiple BSSID sets. The AP 102-a may advertise a value N that spans across the BSSIDs of the multiple sets (such as via the configuration information 315). For example, the set of multiple BSSID sets may include two sets each including four BSSIDs (such as n=2 in each set and N=3 for the entire set). The set of multiple BSSID sets may include eight BSSIDs.

In some examples, the STA 104-a may assume a contiguous set of addresses for the APs 102 within the co-channel collocated set of APs 305. For example, a MAC address range for all APs 102 within the co-channel collocated set of APs may fall within a 48-N range. Advertising the value N may include a relatively low signaling and processing overhead.

In some examples, the AP 102-a may advertise a reference BSSID and the value n for each set (such as via the configuration information 315). Advertising the reference BSSID and the value n may support a co-channel collocated set of APs 305 with addresses that are not contiguous. For each reported set, the AP 102-a may advertise seven octets (such as six octets of a MAC corresponding to the reference BSSID and one octet for the value n).

Advertising the value N or advertising the reference BSSID and the value n may be compatible with the STA 104-a (such as a STA not configured for the cooperative wireless communication) and the STA 104-b (such as an STA configured for the cooperative wireless communication). For example, advertising the value N or advertising the reference BSSID and the value n may be backwards compatible. For example, the STA 104-a may (exclusively) process a local set of addresses.

In examples in which the co-channel collocated set of APs 305 is an example of a cohosted BSSID set, the AP 102-a and the AP 102-b may use a same BSS color. The AP 102-a and the AP 102-b may implement one or more rules for classifying inter-BSS physical layer protocol data unit (PPDU) and intra-BSS PPDUs.

In examples in which the co-channel collocated set of APs 305 is an example of set of multiple BSSID sets, the AP 102-a and the AP 102-b within the co-channel collocated set of APs 305 may use a BSS color based on being within the co-channel collocated set of APs 305. In some examples, each multiple BSSID set may use a different BSS color. The STA 104-a (such as an STA not configured for cooperative wireless communication) within a BSS set may treat the BSS set as in-BSS (such as intra-BSS). The STA 104-b (such as an UHR STA configured for the cooperative wireless communication) may treat all BSSs within the set of multiple BSSID sets as intra-BSS.

In some examples, the APs within the co-channel collocated set of APs 305 may utilize a same BSS color across the set of multiple BSSID sets. The STA 104-a (such as an STA not configured for cooperative wireless communication) may report color collision the STA 104-a receives a transmission with the same color from a BSSID that is not in the same set. The AP 14-a may ignore the color collision from non-UHR STAs (such as the STA 104-a). The non-UHR STAs may not use color for at least some features (such as intra-BSS power saving, spatial reuse, and/or PPDU classification) based on the color collision. The STA 104-b (such as an UHR STA configured for the cooperative wireless communication) may be use BSS color and differentiate between APs outside the co-channel collocated set of APs 305.

In some examples, the AP 102-a and the AP 102-b may operate with disabled color. For example, the AP 102-a may advertise BSS color as disabled (such as via the configuration information 315). A BSS color value included in the transmission may not matter (such as the BSS color value may be a same or different value) based on the disablement. The disablement may indicate that at least some features may not be able to leverage BSS color.

In some examples, the AP 102-a may be (identified as) a coordinator AP for facilitating the channel access and/or for serving any STA from any BSS in the co-channel collocated set of APs 305. For example, the configuration information 315 may indicate that the AP 102-a is the coordinator AP. For example, the AP 102-a may be a coordinator AP for a multiple BSSID set. The AP 102-a may be a transmission BSSID, and the AP 102-a may transmit a single beacon and/or probe response. The AP 102-amay transmit a control frame to STAs that support the control frame.

In a set of multiple BSSID sets a transmission BSSID may be the coordinator AP. Not all STAs may support being served and/or triggered by the coordinator AP. The STA 104-a may transmit an capability field indicating in examples in which the STA 104-a supports being served and/or trigged by a coordinator AP. The capability field may apply to being served and/or triggered to a NPCA primary as well and for operations such as dynamic subchannel operation (DSO) and/or dynamic bandwidth extension (DBE). In DSO, the AP 102-a may employ a DSO procedure to trigger or cause one or more (narrowband) STAs 104 to switch to one or more secondary sub-bands (such as DSO sub-bands) on a dynamic (such as per-TXOP) basis. In DBE, multiple parameter sets may be reported and/or updated by the STA 104-a to match different DBE configurations set by the AP 102-a.

In some examples, any AP within the co-channel collocated set of APs 305 may server or trigger any STA of any BSS in the co-channel collocated set of APs 305. The STAs may be configured to respond to any MAC address in the co-channel collocated set of APs 305. The STA 104-a may transmit a capability field indicating in examples in which the STA 104-a supports being served or triggered by any AP within the co-channel collocated set of APs 305.

In some examples, the co-channel collocated set of APs 305 may support a hybrid configuration. The AP 102-a may be a coordinator AP which may serve STAs that support being served by the AP 102-a. The AP 102-a may pass the TXOP to other APs to serve STAs that do not support the feature. An AID space may be shared across all APs with the co-channel collocated set of APs 305. In some examples, a probe request from the STA 104-b (such as a UHR STA) may result in a single probe response from one of the APs in the set. The probe response may be transmitted from a multiple BSSID set, a co-hosted BSSID, or a set of multiple BSSID sets.

In some examples, the non-collocated AP 102-c may assign an AP identifier to the entire co-channel collocated set of APs 305. The AP 102-c may transmit an indication that the AP 102-c is sharing a TXOP with the co-channel collocated set of APs 305. For example, the AP 102-c may perform TXOP passing to one or more APs of the co-channel collocated set of APs 305. The indication may include the AP identifier assigned to the entire co-channel collocated set of APs 305. In such examples, at least one AP of the co-channel collocated set of APs 305 may communicate within the TXOP in accordance with a TXOP sharing frame including an indication of the AP identifier assigned to the entire co-channel collocated set of APs 305. Further, two or more APs of the co-channel collocated set of APs 305 may coordinate (such as via internal signaling) on a partitioning or sharing of the shared TXOP between two or more APs of the co-channel collocated set of APs 305 in accordance with the TXOP sharing frame including an indication of the AP identifier assigned to the entire co-channel collocated set of APs 305.

In some examples, the non-collocated AP 102-c may assign each AP in the co-channel collocated set of APs 305 a separate AP identifier. The indication that the AP 102-c is sharing the TXOP with the co-channel collocated set of APS 305 may include one of the AP identifiers corresponding to an AP in the co-channel collocated set of APs 305. The AP in the co-channel collocated set that obtains the shared TXOP from the AP 102-c may “silently” (such as via internal signaling, such as via non-over-the-air signaling) share the TXOP with another AP in the co-channel collocated set of APs 305. In other words, the AP in the co-channel collocated set that obtains the shared TXOP from the AP 102-c may further share (at least a portion of) the TXOP with one or more other APs that have AP identifiers within a set of AP identifiers that corresponds to the co-channel collocated set of APs 305.

The properties (such as operations and/or functionality) of the co-channel collocated set of APs 305 may apply to an NPCA primary channel. The NPCA parameters (such as location of NPCA primary) may be the same for all APs in the co-channel collocated set of APs 305. For example, the AP 102-a may transmit an indication of the NPCA parameters via the configuration information 315. All the BSSs in the co-channel collocated set of APs 305 may be considered as in-BSS, and the STAs 104 may not perform NPCA in scenarios in which another AP in the co-channel collocated set is transmitting.

In examples in which a STA supports being served and/or triggered by another AP within a larger set, the trigger also may include a DSO trigger frame. The DSO parameters may be the same for all APs 102 in the co-channel collocated set of APs 305. Additionally, or alternatively, the AP 102-a may enable DBE. DBE may be enabled for all APs in the co-channel collocated set of APs 305 in response to the AP 102-a enabling DBE. The DBE parameters may be the same for all the APs in the co-channel collocated set of APs 305.

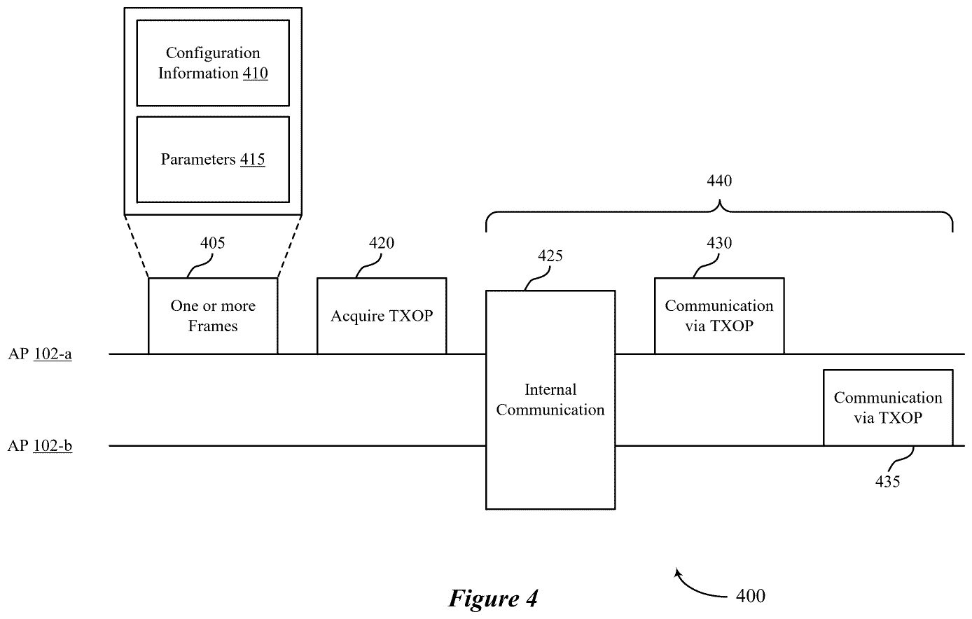

In an illustrative example, the AP 102-a may transmit configuration information 315 and parameters 320 via broadcast signaling. The configuration information 315 may include an indication of a configuration for cooperative wireless communication performed by the co-channel collocated set of APs 305. In some examples, the AP 102-a and the AP 102-b may share a TXOP via internal signaling, as described with reference to FIG. 4. For example, the AP 102-a may obtain a TXOP from a non-collocated AP 102-c. The AP 102-a may share the TXOP with the AP 102-b.

In some examples, the AP 102-a may communicate with the STA 104-a and the STA 104-b in a set of STAs 310-a served by the AP 102-a (such as via communication 325-a). In some examples, the AP 102-a may communicate with the STA 104-c and the STA 104-b in a set of STAs 310-b served by the AP 102-b (such as via communication 325-b). The AP 102-a may communicate with the STAs 104 in accordance with the configuration information 315 and the parameters 320.

FIG. 4 shows an example of a communication timeline 400 that supports cooperative wireless communication between a co-channel collocated set of APs. In some examples, communication timeline 400 may implement aspects of, or be implemented by aspects of, the wireless communication network 100 or the signaling diagram 300. For example, the AP 102-a and the AP 102-b may be an example of corresponding devices described with reference to FIGS. 1 and 3.

At 405, the AP 102-a may transmit one or more frames. The one or more frames may indicate configuration information 410 (such as configuration information 315 as described with reference to FIG. 3) and parameter 415 (such as parameters 320 as described with reference to FIG. 3).

At 420, the AP 102-a may acquire a TXOP 440. The AP 102-a in the co-channel collocated set of APs may gain access to a medium. For example, the AP 102-amay gain access to the medium via channel access, or the AP 102-a may receive the TXOP from another non-collocated AP 102-c (such as C-TDMA).

One or more other APs 102 (such as the AP 102-b) in the co-channel collocated set of APs may utilize a portion of the TXOP. For example, at 425, the AP 102-a and the AP 102-b may internally pass or share a TXOP without over-the-air signaling. At 430, the AP 102-a may communicate with one or more first wireless communication devices via the TXOP. At 435, the AP 102-b may communicate with one or more second wireless communication devices via the TXOP. In some examples, the AP 102-a may pass the TXOP to the AP 102-b after communicating with the one or more first wireless communication devices at operation 430 (such as in a C-TDMA procedure). In some examples, the AP 102-a may communicate with the one or more first wireless communication devices, and the AP 102-b may concurrently communicate with the one or more second wireless communication devices (such as in a CBF procedure or a CSR procedure).

Transmissions from subsequent APs 102 (such as the AP 102-b) in the co-channel collocated set of APs may be short interframe space (SIFS) or point coordination function (PCF) interframe space (PIFS) separated. The TXOP sharing procedure may apply to a cohosted set of APs, a multiple BSSID set, or a set of multiple BSSID sets.

The AP 102-a (such as a coordinator AP) may be designated as a representative of the co-channel collocated set of APs. The AP 102-a may perform channel access and/or may negotiate MAPC procedure (such as C-TDMA) with non-collocated APs on behalf of the set.

The AP 102-a may receive or otherwise obtain the TXOP sharing (such as C-TDMA). Additionally, or alternatively, the AP 102-a may provide aggregate traffic profile and other parameters on behalf of the set. For example, the AP 102-a may transmit the one or more frames 405 based on the AP 102-a being the coordinator AP for the co-channel collocated set of APs. The TXOP sharing procedures described herein may apply whether the channel access is performed on a main primary or a non-primary channel access (NPCA) primary.

In cohosted and multiple BSSID sets, the BSS color may be a same BSS color for all the APs 102 in the co-channel collocated set of APs. Whenever any AP in the co-channel collocated set of APs or non-AP served by the co-channel collocated set transmits a PPDU, the PPDU may set an intra-BSS NAV for the APs 102 and non-APs.

In some examples, the AP 102-a that wins the TXOP or obtains the TXOP from another non-collocated AP may set a relatively long NAV, and any AP in the set may use the TXOP. However, an STA not configured for the cooperative wireless communication may not be expecting a TXOP to be used by a BSS other than the one whose AP wins or obtains the TXOP. The STA may drop a connection with the AP 102-a or the AP 102-b based on falsely identifying the cooperative wireless communication as anomalous activity.

For a set of multiple BSSID sets, each set may have a different color or in examples in which each set has a same color, the STAs 104 may disable color, as described with reference to FIG. 2. A non-AP STA 104 served by the AP 102-b may set a inter BSS NAV and may not respond to the AP 102-b in examples in which the TXOP is passed from the AP 102-a (such as that does not belong to the multiple BSSID set of the non AP STAs) to the AP 102-b.

The AP 102-a may set a relatively short NAV in examples in which the TXOP is to be passed to another AP in the co-channel collocated set of APs (such as the AP 102-b). The duration of the NAV may be up to a duration the AP 102-a expects to be used for in-BSS frame exchanges. The relatively short NAV may ensure that the intra-BSS or inter-BSS NAV is set for the duration that the current AP 102-a may use for frame exchanges. After the duration indicated by the NAV, the NAV may not be set and the non-AP STA 104 may respond to the AP 102-b. For example, the AP 102-a may set a duration indicated by the NAV to expire after the communication performed via the TXOP at operation 430.

In some systems, UHR non-AP STAs may respond to a serving AP even in examples in which a long NAV is set by another AP in the co-channel collocated set of APs. For example, the AP 102-a may set a relatively long NAV and the AP 102-b may serve UHR non-AP STAs 104 during the duration indicated by the relatively long NAV.

The non-collocated AP 102-c (or any other wireless communication device described herein) may set a NAV on a per-PPDU basis. For example, the AP 102-c (or any other wireless communication device) may continue extending a NAV per PPDU or per frame exchange. The non-collocated AP 102-c may set a short NAV (such as a NAV that is less than or equal to a threshold or upper limit NAV), which may be a duration providing protection of transmissions by (or a frame exchange with) the AP 102-c. The duration may end following the transmissions of (or a frame exchange with) the AP 102-c. Additionally, or alternatively, an AP of the set of co-channel collocated APs may set a NAV on a per-PPDU basis, such as to continue extending a NAV per PPDU or per frame exchange. The AP of the set of co-channel collocated APs may set a short NAV (such as a NAV that is less than or equal to a threshold or upper limit NAV, with such a threshold or upper limit NAV potentially being defined for the co-channel collocated set of APs), which may be a duration providing protection of transmissions by (or a frame exchange with) the AP of the set of co-channel collocated APs.

In some examples, in C-TDMA, a sharing AP may transmit an indication in a trigger frame to allocate a time of the TXOP to a shared AP. The trigger frame may be an example of an MU request-to-send (RTS) TXOP sharing (TXS) (MU-RTS TXS) trigger frame, a buffer status report poll (BSRP) trigger frame, or a BSRP. A BSRP trigger frame and a BSRP may generally be referred to as a BSRP message. As such, a BSRP message may be a BSRP trigger frame (such as with a guard interval (GI) field in a common information field not set to a value of 3) or a BSRP (such as with a GI field in a common information field set to a value of 3). A BSRP with a GI field in a common information field set to a value of 3 may be referred to as a BSRP GI3 frame. In some examples, both a BSRP trigger frame and a BSRP GI3 frame may act as a C-TDMA ICF. The trigger frame may act as a C-TDMA initial control frame (ICF). For example, both a BSRP trigger frame and a BSRP GI3 frame may act as a C-TDMA ICF. The trigger frame may include an indication that a TXOP return is to be performed by the shared AP. Following the TXOP return indication, the shared AP may set a NAV on a per PPDU basis within the shared portion of the TXOP. The shared AP may return the TXOP in accordance with the trigger frame, such as by a return time indicated by the trigger frame.

Within the TXOP 440, the AP 102-a and the AP 102-b may perform C-TDMA. In some examples, the AP 102-a (such as a coordinator AP) may provide an aggregate resource requirements for the co-channel collocated set of APs. In some examples, any AP in the co-channel collocated set of APs may provide aggregate resource need for the co-channel collocated set of APs.

The AP 102-a that wins the TXOP 440 may pass the TXOP 440 to another non-collocated AP (such as the AP 102-b). For example, the AP 102-a in the co-channel collocated set of APs may use the TXOP 440 to serve STAs for in-BSS. The AP 102-a may pass the TXOP to another non-collocated AP (which may belong to a second co-channel collocated set). The C-TDMA ICF and TXOP allocation frame may include a transmitter address of the AP 102-a that won the TXOP 440 (such as a first transmission).

The AP 102-a that receives the TXOP 440 from a non-collocated AP may return the TXOP. For example, a transmitter address of the TXOP return frame may be that of the AP 102-a that was polled in the ICF. The AP 102-a may transmit a clear to send (CTS) respond to a TXOP allocation frame.

Additionally, or alternatively, within the TXOP 440, the AP 102-a and the AP 102-b may perform C-RTWT. In some examples, a C-RTWT agreement with non-collocated APs may be independently setup by each AP in a co-channel collocated set of APs. In some examples, a C-RTWT agreement with non-collocated APs may be setup by an AP corresponding to transmission BSSID in a multiple BSSID set. In some examples, a C-RTWT agreement with non-collocated APs may be setup by the coordinator AP in a set of multiple BSSID sets. A beacon frame of the coordinator AP (or the transmitted BSSID), may advertise a C-RTWT schedule of the non-collocated AP. A STA served by (at least one AP of) the co-channel collocated set of APs may communicate in accordance with the advertised C-RTWT schedule. For example, the STA may perform TXOP truncation before a start of a service period indicated by the C-RTWT schedule.

Additionally, or alternatively, within the TXOP 440, the AP 102-a and the AP 102-b may perform dynamic unavailability operation (DUO). Each AP in the set may perform DUO independently. MU-EDCA rules may apply to an AC regardless of which AP in the set triggered the STA to serve traffic belonging to that AC.

Additionally, or alternatively, within the TXOP 440, the AP 102-a and the AP 102-b may perform CSR. The AP 102-a may be a sharing AP. The AP 102-b in the co-channel collocated set of the sharing AP may perform spatial reuse subject to the criteria indicated by the sharing AP. APs participating in a CSR agreement may indicate a transmit power (such as a minimum transmit power) in scenarios of being a shared AP that the sharing AP cannot assign a value less than. The transmit power may vary from one AP within the co-channel collocated set to another.

Additionally, or alternatively, within the TXOP 440, the AP 102-a and the AP 102-b may perform CBF. For CSR and/or CBF, the co-channel collocated set of APs may negotiate one or more MAPC agreements with a non-collocated AP. In some examples, the AP 102-a (such as a coordinator AP) may negotiate a single MAPC agreement with a non-collocated AP as a representative of the co-channel collocated set of APs. A parameter set of the MAPC may be representative of the co-channel collocated set of APs (such as a minimum and/or maximum across the co-channel collocated set of APs, such as a maximum coherence time). In some examples, some APs may have lower coherence time, which may be represented in the parameter set. All over-the-air communication between the non-collocated AP and the co-channel collocated set of APs may be with the coordinator AP.

In some examples, the co-channel collocated set of APs may use a common set of parameters and per-BSS parameters. For example, the parameter set for the MAPC may include a common set of parameters and per-BSS parameters that are independent for each respective BSS. In some examples, over-the-air communication pertaining to the MAPC may be exclusively with the coordinator AP and one or more other non-collocated APs.

In some examples the AP 102-a (such as the coordinator AP) may negotiate multiple MAPC agreement with a non-collocated AP with per-BSS parameter set (such as coherence time of each BSS). In such examples, each BSS within the co-channel collocated set of APs may be defined with a respective parameter set. All over-the-air communication between the non-collocated AP and the co-channel collocated set of APs may be with the coordinator AP.

In some examples, each AP in the co-channel collocated set of APs may perform negotiation using a parameter set of the respective AP. For example, the AP 102-a and the AP 102-b may both negotiate a MAPC agreement using respective parameter sets.

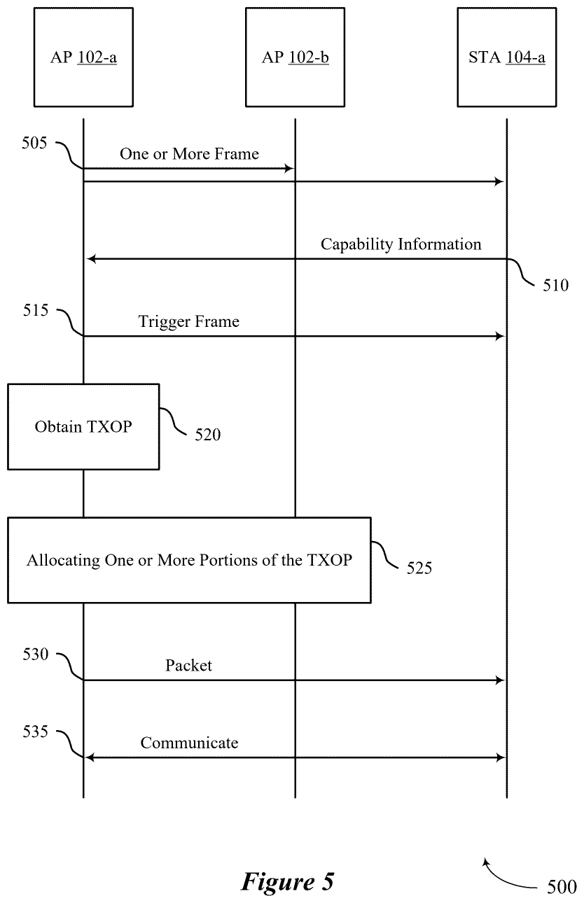

FIG. 5 shows an example of a process flow 500 that supports cooperative wireless communication between a co-channel collocated set of APs. In some examples, process flow 500 may implement aspects of, or be implemented by aspects of, the wireless communication network 100, the signaling diagram 300, or the communication timeline 400. For example, the AP 102-a, the AP 102-b, and STA 104-a may be examples of corresponding devices described with reference to FIG. 1-4.

At 505, the AP 102-a may transmit one or more frames that include information indicative of a configuration of a co-channel collocated set of APs. The co-channel collocated set of APs may include the AP 102-a. The co-channel collocated set of APs may include a coordinator AP that facilitates cooperative wireless communication performed by the co-channel collocated set of APs. In some examples, the one or more frames may include one or more management frames. In some examples, the co-channel collocated set of APs may be associated with a single AID.

In some examples, the cooperative wireless communication performed by the co-channel collocated set of APs include TXOP sharing between the co-channel collocated set of APs. The coordinator AP may facilitate the cooperative wireless communication performed by the co-channel collocated set of APs by obtaining and/or releasing a TXOP on behalf of the co-channel collocated set of APs. The AP 102-a may communicate with the one or more wireless communication devices within the TXOP obtained by the coordinator AP.

In some examples, an element of the one or more frames may indicate the configuration of the co-channel collocated set of APs and/or a set of parameters that is applicable to each AP of the co-channel collocated set of APs. The element may be a collocated AP set parameters element.

In some examples, in accordance with the cooperative wireless communication performed by the co-channel collocated set of APs, each AP of the co-channel collocated set of APs may enable a DBE operation mode in response to at least one AP of the co-channel collocated set of APs enabling the dynamic bandwidth expansion operation mode.

In some examples, the co-channel collocated set of APs may include a set of multiple BSSID sets. In some examples, the configuration of the co-channel collocated set of APs include a first indication of a first quantity of BSSIDs in each multiple BSSID set of the set of multiple BSSID sets, and a second indication of a second quantity of BSSIDs across the set of multiple BSSID sets of the co-channel collocated set of APs. In some examples, the configuration of the co-channel collocated set of APs further includes, for each multiple BSSID set of the plurality of multiple BSSID sets, a first indication of a reference BSSID for that multiple BSSID set, and a second indication of a quantity of BSSIDs in that multiple BSSID set.

In some examples, each multiple BSSID set of the set of multiple BSSID sets corresponds to a different BSS color of a set of BSS colors. In some examples, each multiple BSSID set of the plurality of multiple BSSID sets corresponds to a same BSS color. In some examples, the cooperative wireless communication is in accordance with a disablement of a BSS color.

In some examples, the cooperative wireless communication performed by the co-channel collocated set of APs may be in accordance with an interpretation, by first wireless communication devices that have a first capability, of different BSS colors of the plurality of BSS colors as being indicative of intra-BSS (such as in-BSS) communication. Second wireless communication devices that have a second capability may interpret the different BSS colors of the plurality of BSS colors as being indicative of inter-BSS communication.

In some examples, the cooperative wireless communication performed by the co-channel collocated set of APs may be in accordance with ignoring, by APs of the co-channel collocated set of APs, of color collision reports from wireless communication devices having less than a threshold capability. The configuration of the co-channel collocated set of APs may indicate the disablement of the BSS color.

In some examples, the coordinator AP may facilitate the cooperative wireless communication performed by the co-channel collocated set of APs by negotiating a single multi-AP coordination agreement with a non-collocated AP regarding a coordinated beamforming operation mode. The single multi-AP coordination agreement may indicate a single coordinated beamforming parameter set that is applicable to each AP of the co-channel collocated set of APs, or a common coordinated beamforming parameter set that is applicable to each AP of the co-channel collocated set of APs and a set of AP-specific coordinated beamforming parameter sets. Each AP-specific coordinated beamforming parameter set of the plurality of AP-specific coordinated beamforming parameter sets may correspond to a respective AP of the co-channel collocated set of APs.

In some examples, the coordinator AP may facilitate the cooperative wireless communication performed by the co-channel collocated set of APs by negotiating a plurality of multi-AP coordination agreements with a non-collocated AP regarding a coordinated beamforming operation mode. Each multi-AP coordination agreement of the set of multi-AP coordination agreements may indicates a respective coordinated beamforming parameter set that corresponds to a respective AP of the co-channel collocated set of APs.

In some examples, each AP of the co-channel collocated set of APs may perform a respective negotiation of a respective multi-AP coordination agreement regarding a coordinated beamforming operation mode. Each multi-AP coordination agreement may indicate a respective coordinated beamforming parameter set that corresponds to that AP of the co-channel collocated set of APs.

In some examples, the coordinator AP facilitates the cooperative wireless communication performed by the co-channel collocated set of APs by indicating at least one criterion regarding a spatial reuse, within a TXOP obtained by the coordinator AP, by one or more other APs within the co-channel collocated set of APs.

In some examples, the coordinator AP is an AP of the co-channel collocated set of APs that obtains a TXOP as a result of a channel access procedure, obtains a shared TXOP from a non-collocated AP, and/or serves a STA associated with another AP of the co-channel collocated set of APs.

In some examples, the configuration of the co-channel collocated set of APs may include an identifier of the coordinator AP that facilitates the cooperative wireless communication performed by the co-channel collocated set of APs.

In some examples, at least one frame of the one or more frames may include additional information indicative of a set of parameters applicable to each AP of the co-channel collocated set of APs. The set of parameters may indicate one or more rules defined for the co-channel collocated set of APs and/or one or more operational parameters defined for the co-channel collocated set of APs.

At 510, the AP 102-a may receive, from each wireless communication device of the one or more wireless communication devices associated with the AP 102-a of the co-channel collocated set of APs, an indication of a capability of that wireless communication device to support being served by other APs of the co-channel collocated set of APs outside of the second AP.

At 515, the AP 102-a may transmit a frame that triggers at least one wireless communication device of the one or more wireless communication devices to switch from a first subchannel within an operating bandwidth to a second subchannel within the operating bandwidth.

At 520, the AP 102-a may obtain the TXOP as a result of performing a channel access procedure or as a result of negotiating a multi-AP coordination procedure. In some examples, the AP 102-a becomes the coordinator AP in accordance with obtaining the TXOP. In some examples, the AP 102-a performs the channel access procedure and/or negotiates the multi-AP coordination procedure in accordance with the first AP being the coordinator AP.

In some examples, the AP 102-a may receive an indication that a TXOP is shared with the AP 102-a. In some examples, the indication that the TXOP is shared includes an AP identifier of the co-channel collocated set of APs. In some examples, the indication that the TXOP is shared may include an AP identifier of the AP 102-a. In some examples, the AP 102-a may receive a trigger frame indicating an allocation of a time duration of a TXOP to the AP 102-a. In some examples, the trigger frame may be a BSRP message.

At 525, the AP 102-a may allocate one or more portions of the TXOP to one or more other APs (such as the AP 102-b) of the co-channel collocated set of APs in accordance with obtaining the TXOP. The cooperative wireless communication performed by the co-channel collocated set of APs may include allocating the one or more portions of the TXOP to the one or more other APs (such as the AP 102-b) of the co-channel collocated set of APs. In some examples, the one or more portions of the TXOP includes frequency domain resources, spatial resources, and/or time domain resources.

At 530, the AP 102-a may transmit, within the TXOP, a packet that includes an indication of a NAV. In some examples, a duration of the NAV is based on a sharing of the TXOP between two or more APs of the co-channel collocated set of APs. In some examples, the duration of the NAV may exclusively protect frame exchanges with the AP 102-a based on the sharing of the TXOP between the two or more APs of the co-channel collocated set of APs. Each AP of the co-channel collocated set of APs may have prioritized channel access within the TXOP.

At 535, the AP 102-a may communicate with one or more wireless communication devices (such as the STA 104-a) in accordance with the configuration of the co-channel collocated set of APs.

In some examples, the one or more wireless communication devices may include one or more STAs associated with the AP 102-b of the co-channel collocated set of APs. The first AP communicates with the one or more STAs associated with the AP 102-b of the co-channel collocated set of APs in accordance with the AP 102-a being the coordinator AP. In some examples, the one or more wireless communication devices are associated with the AP 102-a of the co-channel collocated set of APs. The cooperative wireless communication performed by the co-channel collocated set of APs includes the first AP being able to serve wireless communication devices associated with the second AP. The AP 102-a may communicate with the one or more wireless communication devices associated with the AP 102-b is in accordance with the capability received at operation 510.

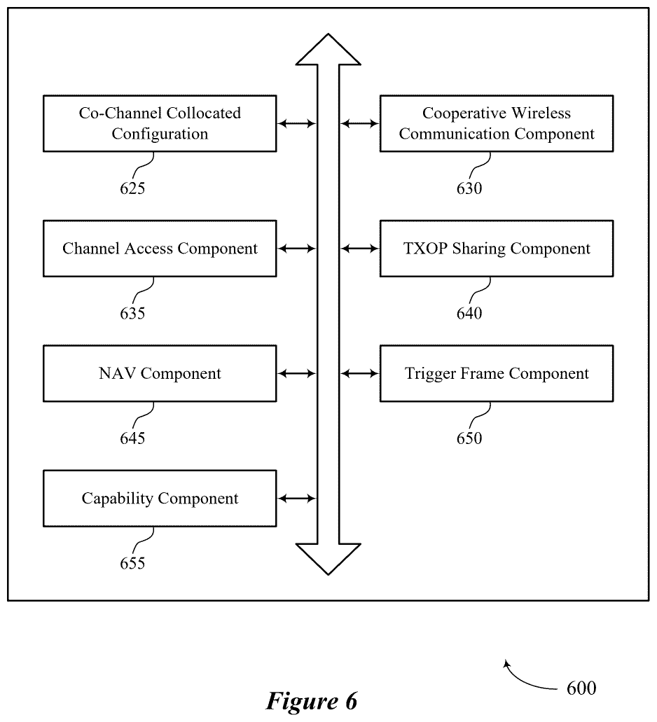

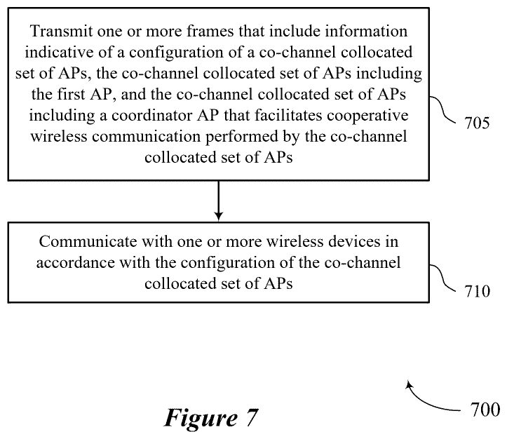

FIG. 6 shows a block diagram of an example wireless communication device 600 that supports cooperative wireless communication between a co-channel collocated set of APs. In some examples, the wireless communication device 600 is configured to perform the processes 700, 800, and 900 described with reference to FIGS. 7, 8, and 9, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communication in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communication conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a co-channel collocated configuration 625, a cooperative wireless communication component 630, a channel access component 635, a TXOP sharing component 640, a NAV component 645, a trigger frame component 650, and a capability component 655. Portions of one or more of the co-channel collocated configuration 625, the cooperative wireless communication component 630, the channel access component 635, the TXOP sharing component 640, the NAV component 645, the trigger frame component 650, and the capability component 655 may be implemented at least in part in hardware or firmware. For example, one or more of the co-channel collocated configuration 625, the cooperative wireless communication component 630, the channel access component 635, the TXOP sharing component 640, the NAV component 645, the trigger frame component 650, and the capability component 655 may be implemented at least in part by at least a processor or a modem. In some examples, portions of one or more of the co-channel collocated configuration 625, the cooperative wireless communication component 630, the channel access component 635, the TXOP sharing component 640, the NAV component 645, the trigger frame component 650, and the capability component 655 may be implemented at least in part by a processor and software in the form of processor-executable code stored in memory.

The wireless communication device 600 may support wireless communication in accordance with examples as disclosed herein. The co-channel collocated configuration 625 is configurable or configured to transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs. The cooperative wireless communication component 630 is configurable or configured to communicate with one or more wireless communication devices in accordance with the configuration of the co-channel collocated set of APs.

In some examples, the cooperative wireless communication performed by the co-channel collocated set of APs includes TXOP sharing between the co-channel collocated set of APs, the coordinator AP facilitates the cooperative wireless communication performed by the co-channel collocated set of APs by obtaining or releasing a TXOP on behalf of the co-channel collocated set of APs, and the first AP communicates with the one or more wireless communication devices within the TXOP obtained by the coordinator AP.

In some examples, the channel access component 635 is configurable or configured to obtain the TXOP as a result of performing a channel access procedure or as a result of negotiating a multi-AP coordination procedure. In some examples, the TXOP sharing component 640 is configurable or configured to allocate one or more portions of the TXOP to one or more other APs of the co-channel collocated set of APs in accordance with obtaining the TXOP. In some examples, the cooperative wireless communication performed by the co-channel collocated set of APs includes allocating the one or more portions of the TXOP to the one or more other APs of the co-channel collocated set of APs.

In some examples, the one or more portions of the TXOP include, spatial resources, time domain resources, or any combination thereof. In some examples, the first AP becomes the coordinator AP in accordance with obtaining the TXOP. In some examples, the first AP performs the channel access procedure or negotiates the multi-AP coordination procedure in accordance with the first AP being the coordinator AP.

In some examples, the one or more wireless communication devices include one or more STAs associated with a second AP of the co-channel collocated set of APs. In some examples, the first AP communicates with the one or more STAs associated with the second AP of the co-channel collocated set of APs in accordance with the first AP being the coordinator AP.

In some examples, the channel access component 635 is configurable or configured to receive an indication that a TXOP is shared with the first AP. In some examples, the indication that the TXOP is shared includes an AP identifier of the co-channel collocated set of APs.

In some examples, the channel access component 635 is configurable or configured to receive an indication that a TXOP is shared with the first AP. In some examples, the indication that the TXOP is shared includes an AP identifier of the first AP.

In some examples, the channel access component 635 is configurable or configured to receive a trigger frame indicating an allocation of a time duration of a TXOP to the first AP. In some examples, the trigger frame is a BSRP message.

In some examples, to support communicating with the one or more wireless communication devices, the NAV component 645 is configurable or configured to transmit, within the TXOP, a packet that includes an indication of a NAV. In some examples, a duration of the NAV is based on a sharing of the TXOP between two or more APs of the co-channel collocated set of APs.

In some examples, the duration of the NAV exclusively protects frame exchanges with the first AP based on the sharing of the TXOP between the two or more APs of the co-channel collocated set of APs, and each AP of the co-channel collocated set of APs has prioritized channel access within the TXOP.

In some examples, the one or more wireless communication devices are associated with a second AP of the co-channel collocated set of APs. In some examples, the cooperative wireless communication performed by the co-channel collocated set of APs includes the first AP being able to serve wireless communication devices associated with the second AP.

In some examples, to support communicating with the one or more wireless communication devices, the trigger frame component 650 is configurable or configured to transmit a frame that triggers at least one wireless communication device of the one or more wireless communication devices to switch from a first subchannel within an operating bandwidth to a second subchannel within the operating bandwidth.

In some examples, the capability component 655 is configurable or configured to receive, from each wireless communication device of the one or more wireless communication devices associated with the second AP of the co-channel collocated set of APs, an indication of a capability of that wireless communication device to support being served by other APs of the co-channel collocated set of APs outside of the second AP. In some examples, communicating with the one or more wireless communication devices associated with the second AP is in accordance with the capability.

In some examples, the co-channel collocated set of APs includes a set of multiple BSSID sets. In some examples, the configuration of the co-channel collocated set of APs includes a first indication of a first quantity of BSSIDs in each multiple BSSID set of the plurality of multiple BSSID sets, and a second indication of a second quantity of BSSIDs across the plurality of multiple BSSID sets of the co-channel collocated set of APs.

In some examples, the co-channel collocated set of APs includes a set of multiple BSSID sets. In some examples, the configuration of the co-channel collocated set of APs further includes, for each multiple BSSID set of the plurality of multiple BSSID sets, a first indication of a reference BSSID for that multiple BSSID set, and a second indication of a quantity of BSSIDs in that multiple BSSID set.

In some examples, the co-channel collocated set of APs includes a set of multiple BSSID sets. In some examples, each multiple BSSID set of the set of multiple BSSID sets corresponds to a different BSS color of a set of multiple BSS colors.

In some examples, the cooperative wireless communication performed by the co-channel collocated set of APs is in accordance with an interpretation, by first wireless communication devices that have a first capability, of different BSS colors of the set of multiple BSS colors as being indicative of intra-BSS communication, and second wireless communication devices that have a second capability interpret the different BSS colors of the set of multiple BSS colors as being indicative of inter-BSS communication.

In some examples, the co-channel collocated set of APs includes a set of multiple BSSID sets. In some examples, each multiple BSSID set of the set of multiple BSSID sets corresponds to a same BSS color.

In some examples, the cooperative wireless communication performed by the co-channel collocated set of APs is in accordance with ignoring, by APs of the co-channel collocated set of APs, of color collision reports from wireless communication devices having less than a threshold capability.

In some examples, the co-channel collocated set of APs includes a set of multiple BSSID sets. In some examples, the cooperative wireless communication is in accordance with a disablement of a BSS color.

In some examples, the configuration of the co-channel collocated set of APs indicates the disablement of the BSS color.

In some examples, in accordance with the cooperative wireless communication performed by the co-channel collocated set of APs, each AP of the co-channel collocated set of APs enables a dynamic bandwidth expansion operation mode in response to at least one AP of the co-channel collocated set of APs enabling the dynamic bandwidth expansion operation mode.

In some examples, the one or more frames include one or more management frames.

In some examples, an element of the one or more frames indicates the configuration of the co-channel collocated set of APs, a set of parameters that is applicable to each AP of the co-channel collocated set of APs, or both.

In some examples, the element is a collocated AP set parameters element.

In some examples, at least one frame of the one or more frames includes additional information indicative of a set of parameters applicable to each AP of the co-channel collocated set of APs. In some examples, the set of parameters indicate one or more rules defined for the co-channel collocated set of APs, one or more operational parameters defined for the co-channel collocated set of APs, or any combination thereof.

In some examples, the coordinator AP facilitates the cooperative wireless communication performed by the co-channel collocated set of APs by negotiating a single multi-AP coordination agreement with a non-collocated AP regarding a coordinated beamforming operation mode. In some examples, the single multi-AP coordination agreement indicates a single coordinated beamforming parameter set that is applicable to each AP of the co-channel collocated set of APs, or a common coordinated beamforming parameter set that is applicable to each AP of the co-channel collocated set of APs and a set of multiple AP-specific coordinated beamforming parameter sets, each AP-specific coordinated beamforming parameter set of the set of multiple AP-specific coordinated beamforming parameter sets corresponding to a respective AP of the co-channel collocated set of APs.

In some examples, the coordinator AP facilitates the cooperative wireless communication performed by the co-channel collocated set of APs by negotiating a plurality of multi-AP coordination agreements with a non-collocated AP regarding a coordinated beamforming operation mode. In some examples, each multi-AP coordination agreement of the plurality of multi-AP coordination agreements indicates a respective coordinated beamforming parameter set that corresponds to a respective AP of the co-channel collocated set of APs.

In some examples, each AP of the co-channel collocated set of APs performs a respective negotiation of a respective multi-AP coordination agreement regarding a coordinated beamforming operation mode. In some examples, each multi-AP coordination agreement indicates a respective coordinated beamforming parameter set that corresponds to that AP of the co-channel collocated set of APs.

In some examples, the coordinator AP facilitates the cooperative wireless communication performed by the co-channel collocated set of APs by indicating at least one criterion regarding a spatial reuse, within a TXOP obtained by the coordinator AP, by one or more other APs within the co-channel collocated set of APs.

In some examples, the coordinator AP is an AP of the co-channel collocated set of APs that obtains a TXOP as a result of a channel access procedure, obtains a shared TXOP from a non-collocated AP, or serves a STA associated with another AP of the co-channel collocated set of APs.

In some examples, the configuration of the co-channel collocated set of APs includes an identifier of the coordinator AP that facilitates the cooperative wireless communication performed by the co-channel collocated set of APs.

In some examples, the co-channel collocated set of APs may be associated with a single AID.

FIG. 7 shows a flowchart illustrating an example process 700 performable by or at a first AP that supports cooperative wireless communication between a co-channel collocated set of APs. The operations of the process 700 may be implemented by a first AP or its components. For example, the process 700 may be performed by a wireless communication device, such as the wireless communication device 600 described with reference to FIG. 6, operating as or within a wireless AP. In some examples, the process 700 may be performed by a wireless AP, such as one of the APs 102 described with reference to FIG. 1.

In some examples, in 705, the first AP may transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs. In some implementations, aspects of the operations of 705 may be performed by a co-channel collocated configuration 625 as described with reference to FIG. 6.

In some examples, in 710, the first AP may communicate with one or more wireless communication devices in accordance with the configuration of the co-channel collocated set of APs. In some implementations, aspects of the operations of 710 may be performed by a cooperative wireless communication component 630 as described with reference to FIG. 6.

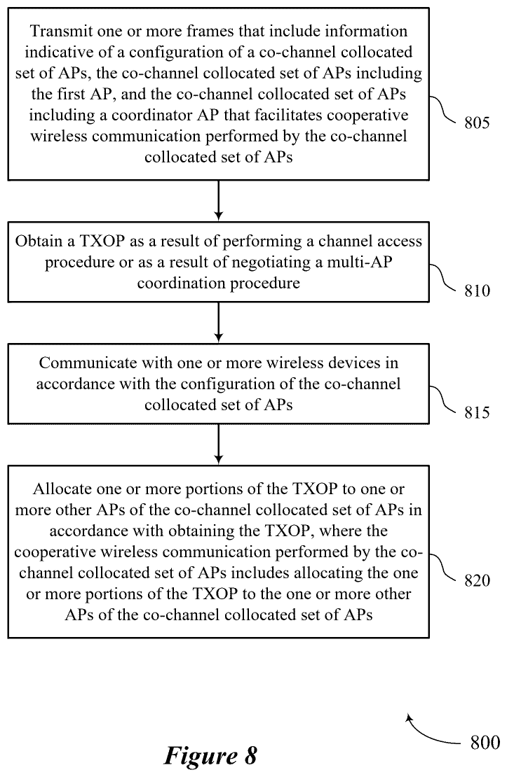

FIG. 8 shows a flowchart illustrating an example process 800 performable by or at a first AP that supports cooperative wireless communication between a co-channel collocated set of APs. The operations of the process 800 may be implemented by a first AP or its components. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in 805, the first AP may transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs. In some implementations, aspects of the operations of 805 may be performed by a co-channel collocated configuration 625 as described with reference to FIG. 6.

In some examples, in 810, the first AP may obtain the TXOP as a result of performing a channel access procedure or as a result of negotiating a multi-AP coordination procedure. In some implementations, aspects of the operations of 810 may be performed by a channel access component 635 as described with reference to FIG. 6.

In some examples, in 815, the first AP may communicate with one or more wireless communication devices in accordance with the configuration of the co-channel collocated set of APs. In some implementations, aspects of the operations of 815 may be performed by a cooperative wireless communication component 630 as described with reference to FIG. 6.

In some examples, in 820, the first AP may allocate one or more portions of the TXOP to one or more other APs of the co-channel collocated set of APs in accordance with obtaining the TXOP. In some examples, the cooperative wireless communication performed by the co-channel collocated set of APs includes allocating the one or more portions of the TXOP to the one or more other APs of the co-channel collocated set of APs. In some implementations, aspects of the operations of 820 may be performed by a TXOP sharing component 640 as described with reference to FIG. 6.

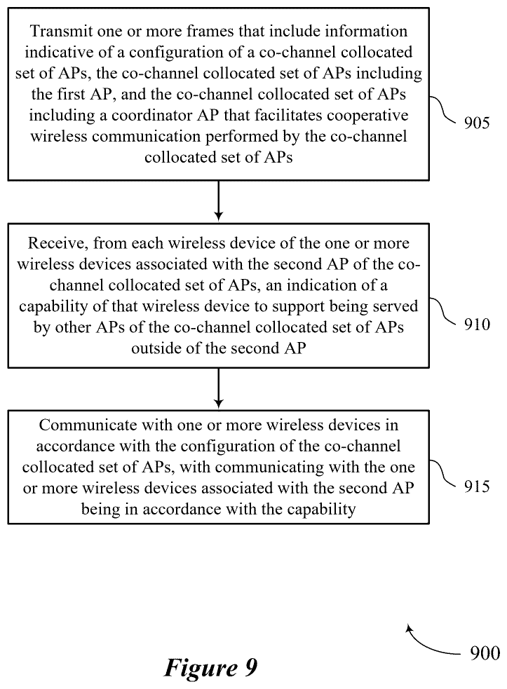

FIG. 9 shows a flowchart illustrating an example process 900 performable by or at a first AP that supports cooperative wireless communication between a co-channel collocated set of APs. The operations of the process 900 may be implemented by a first AP or its components. For example, the process 900 may be performed by a wireless communication device, such as the wireless communication device 600 described with reference to FIG. 6, operating as or within a wireless AP. In some examples, the process 900 may be performed by a wireless AP, such as one of the APs 102 described with reference to FIG. 1.

In some examples, in 905, the first AP may transmit one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs. In some implementations, aspects of the operations of 905 may be performed by a co-channel collocated configuration 625 as described with reference to FIG. 6.

In some examples, in 910, the first AP may receive, from each wireless communication device of the one or more wireless communication devices associated with the second AP of the co-channel collocated set of APs, an indication of a capability of that wireless communication device to support being served by other APs of the co-channel collocated set of APs outside of the second AP. In some implementations, aspects of the operations of 910 may be performed by a capability component 655 as described with reference to FIG. 6.

In some examples, in 915, the first AP may communicate with one or more wireless communication devices in accordance with the configuration of the co-channel collocated set of APs, with communicating with the one or more wireless communication devices associated with the second AP being in accordance with the capability. In some implementations, aspects of the operations of 915 may be performed by a cooperative wireless communication component 630 as described with reference to FIG. 6.

Implementation examples are described in the following numbered clauses:

Clause 1: A method for wireless communication by a first AP, including: transmitting one or more frames that include information indicative of a configuration of a co-channel collocated set of APs, the co-channel collocated set of APs including the first AP, and the co-channel collocated set of APs including a coordinator AP that facilitates cooperative wireless communication performed by the co-channel collocated set of APs; and communicating with one or more wireless devices in accordance with the configuration of the co-channel collocated set of APs.

Clause 2: The method of clause 1, where the cooperative wireless communication performed by the co-channel collocated set of APs includes TXOP sharing between the co-channel collocated set of APs, the coordinator AP facilitates the cooperative wireless communication performed by the co-channel collocated set of APs by obtaining or releasing a TXOP on behalf of the co-channel collocated set of APs, and the first AP communicates with the one or more wireless devices within the TXOP obtained by the coordinator AP.

Clause 3: The method of clause 2, further including: obtaining the TXOP as a result of performing a channel access procedure or as a result of negotiating a multi-AP coordination procedure; and allocating one or more portions of the TXOP to one or more other APs of the co-channel collocated set of APs in accordance with obtaining the TXOP, where the cooperative wireless communication performed by the co-channel collocated set of APs includes allocating the one or more portions of the TXOP to the one or more other APs of the co-channel collocated set of APs.

Clause 4: The method of clause 3, where the one or more portions of the TXOP include, spatial resources, time domain resources, or any combination thereof.

Clause 5: The method of any of clauses 3-5, where the first AP becomes the coordinator AP in accordance with obtaining the TXOP.

Clause 6: The method of any of clauses 3-5, where the first AP performs the channel access procedure or negotiates the multi-AP coordination procedure in accordance with the first AP being the coordinator AP.

Clause 7: The method of any of clauses 3-6, where the one or more wireless devices include one or more STAs associated with a second AP of the co-channel collocated set of APs, and the first AP communicates with the one or more STAs associated with the second AP of the co-channel collocated set of APs in accordance with the first AP being the coordinator AP.

Clause 8: The method of any of clauses 2-7, where communicating with the one or more wireless devices includes: transmitting, within the TXOP, a packet that includes an indication of a NAV, where a duration of the NAV is based at least in part on a sharing of the TXOP between two or more APs of the co-channel collocated set of APs.

Clause 9: The method of clause 8, where the duration of the NAV exclusively protects frame exchanges with the first AP based at least in part on the sharing of the TXOP between the two or more APs of the co-channel collocated set of APs, and each AP of the co-channel collocated set of APs has prioritized channel access within the TXOP.

Clause 10: The method of any of clauses 1-9, where the one or more wireless devices are associated with a second AP of the co-channel collocated set of APs, and the cooperative wireless communication performed by the co-channel collocated set of APs includes the first AP being able to serve wireless devices associated with the second AP.

Clause 11: The method of clause 10, where communicating with the one or more wireless devices includes: transmitting a frame that triggers at least one wireless device of the one or more wireless devices to switch from a first subchannel within an operating bandwidth to a second subchannel within the operating bandwidth.

Clause 12: The method of any of clauses 10-11, further including: receiving, from each wireless device of the one or more wireless devices associated with the second AP of the co-channel collocated set of APs, an indication of a capability of that wireless device to support being served by other APs of the co-channel collocated set of APs outside of the second AP, where communicating with the one or more wireless devices associated with the second AP is in accordance with the capability.

Clause 13: The method of any of clauses 1-12, where the co-channel collocated set of APs includes a plurality of multiple BSSID sets, and where the configuration of the co-channel collocated set of APs further includes: a first indication of a first quantity of BSSIDs in each multiple BSSID set of the plurality of multiple BSSID sets, and a second indication of a second quantity of BSSIDs across the plurality of multiple BSSID sets of the co-channel collocated set of APs.

Clause 14: The method of any of clauses 1-12, where the co-channel collocated set of APs includes a plurality of multiple BSSID sets, and where the configuration of the co-channel collocated set of APs further includes, for each multiple BSSID set of the plurality of multiple BSSID sets: a first indication of a reference BSSID for that multiple BSSID set, and a second indication of a quantity of BSSIDs in that multiple BSSID set.

Clause 15: The method of any of clauses 1-14, where the co-channel collocated set of APs includes a plurality of multiple BSSID sets, and each multiple BSSID set of the plurality of multiple BSSID sets corresponds to a different BSS color of a plurality of BSS colors.

Clause 16: The method of clause 15, where the cooperative wireless communication performed by the co-channel collocated set of APs is in accordance with an interpretation, by first wireless devices that have a first capability, of different BSS colors of the plurality of BSS colors as being indicative of intra-BSS communication, and second wireless devices that have a second capability interpret the different BSS colors of the plurality of BSS colors as being indicative of inter-BSS communication.

Clause 17: The method of any of clauses 1-14, where the co-channel collocated set of APs includes a plurality of multiple BSSID sets, and each multiple BSSID set of the plurality of multiple BSSID sets corresponds to a same BSS color.

Clause 18: The method of clause 17, where the cooperative wireless communication performed by the co-channel collocated set of APs is in accordance with ignoring, by APs of the co-channel collocated set of APs, of color collision reports from wireless devices having less than a threshold capability.

Clause 19: The method of any of clauses 1-14, where the co-channel collocated set of APs includes a plurality of multiple BSSID sets, and the cooperative wireless communication is in accordance with a disablement of a BSS color.

Clause 20: The method of clause 19, where the configuration of the co-channel collocated set of APs indicates the disablement of the BSS color.

Clause 21: The method of any of clauses 1-20, where in accordance with the cooperative wireless communication performed by the co-channel collocated set of APs, each AP of the co-channel collocated set of APs enables a dynamic bandwidth expansion operation mode in response to at least one AP of the co-channel collocated set of APs enabling the dynamic bandwidth expansion operation mode.

Clause 22: The method of any of clauses 1-21, where the one or more frames include one or more management frames.

Clause 23: The method of any of clauses 1-22, where an element of the one or more frames indicates the configuration of the co-channel collocated set of APs, a set of parameters that is applicable to each AP of the co-channel collocated set of APs, or both.

Clause 24: The method of clause 23, where the element is a collocated AP set parameters element.

Clause 25: The method of any of clauses 1-24, where at least one frame of the one or more frames includes additional information indicative of a set of parameters applicable to each AP of the co-channel collocated set of APs, and the set of parameters indicate one or more rules defined for the co-channel collocated set of APs, one or more operational parameters defined for the co-channel collocated set of APs, or any combination thereof.

Clause 26: The method of any of clauses 1-25, where the coordinator AP facilitates the cooperative wireless communication performed by the co-channel collocated set of APs by negotiating a single multi-AP coordination agreement with a non-collocated AP regarding a coordinated beamforming operation mode, and where the single multi-AP coordination agreement indicates a single coordinated beamforming parameter set that is applicable to each AP of the co-channel collocated set of APs, or a common coordinated beamforming parameter set that is applicable to each AP of the co-channel collocated set of APs and a plurality of AP-specific coordinated beamforming parameter sets, each AP-specific coordinated beamforming parameter set of the plurality of AP-specific coordinated beamforming parameter sets corresponding to a respective AP of the co-channel collocated set of APs.

Clause 27: The method of any of clauses 1-25, where the coordinator AP facilitates the cooperative wireless communication performed by the co-channel collocated set of APs by negotiating a plurality of multi-AP coordination agreements with a non-collocated AP regarding a coordinated beamforming operation mode, and where each multi-AP coordination agreement of the plurality of multi-AP coordination agreements indicates a respective coordinated beamforming parameter set that corresponds to a respective AP of the co-channel collocated set of APs.

Clause 28: The method of any of clauses 1-25, where each AP of the co-channel collocated set of APs performs a respective negotiation of a respective multi-AP coordination agreement regarding a coordinated beamforming operation mode, and each multi-AP coordination agreement indicates a respective coordinated beamforming parameter set that corresponds to that AP of the co-channel collocated set of APs.

Clause 29: The method of any of clauses 1-28, where the coordinator AP facilitates the cooperative wireless communication performed by the co-channel collocated set of APs by indicating at least one criterion regarding a spatial reuse, within a TXOP obtained by the coordinator AP, by one or more other APs within the co-channel collocated set of APs.

Clause 30: The method of any of clauses 1-29, where the coordinator AP is an AP of the co-channel collocated set of APs that obtains a TXOP as a result of a channel access procedure, obtains a shared TXOP from a non-collocated AP, or serves a STA associated with another AP of the co-channel collocated set of APs.

Clause 31: The method of any of clauses 1-30, where the configuration of the co-channel collocated set of APs includes an identifier of the coordinator AP that facilitates the cooperative wireless communication performed by the co-channel collocated set of APs.

Clause 32: The method of any of clauses 1-31, further including: receiving an indication that a TXOP is shared with the first AP, where the indication that the TXOP is shared includes an AP identifier of the co-channel collocated set of APs

Clause 33: The method of any of clauses 1-31, further including: receiving an indication that a TXOP is shared with the first AP, where the indication that the TXOP is shared includes an AP identifier of the first AP.

Clause 34: The method of any of clauses 1-33, where the co-channel collocated set of APs may be associated with a single AID.

Clause 35: The method of any of clauses 1-34, further including: receiving a trigger frame indicating an allocation of a time duration of a TXOP to the first AP, where the trigger frame is a BSRP message

Clause 36: A first AP for wireless communication, including a processing system that includes processor circuitry and memory circuitry that stores code, the processing system configured to cause the first AP to perform a method of any of clauses 1-35.

Clause 37: A first AP for wireless communication, including at least one means for performing a method of any of clauses 1-35.

Clause 38: A non-transitory computer-readable medium storing code for wireless communication, the code including instructions executable by one or more processors to perform a method of any of clauses 1-35.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit one or more frames that comprise information indicative of a configuration of a co-channel collocated set of APs, the co-channel collocated set of APs comprising the first AP, and the co-channel collocated set of APs comprising a coordinator AP that facilitates cooperative wireless communication performed by the co-channel collocated set of APs; and
communicate with one or more wireless communication devices in accordance with the configuration of the co-channel collocated set of APs.

2. The first AP of claim 1, wherein:
the cooperative wireless communication performed by the co-channel collocated set of APs comprises transmission opportunity (TXOP) sharing between the co-channel collocated set of APs,
the coordinator AP facilitates the cooperative wireless communication performed by the co-channel collocated set of APs by obtaining or releasing a TXOP on behalf of the co-channel collocated set of APs, and
the first AP communicates with the one or more wireless communication devices within the TXOP obtained by the coordinator AP.

3. The first AP of claim 2, wherein the processing system is further configured to cause the first AP to:
obtain the TXOP as a result of performing a channel access procedure or as a result of negotiating a multi-AP coordination procedure; and
allocate one or more portions of the TXOP to one or more other APs of the co-channel collocated set of APs in accordance with obtaining the TXOP, wherein the cooperative wireless communication performed by the co-channel collocated set of APs comprises allocating the one or more portions of the TXOP to the one or more other APs of the co-channel collocated set of APs.

4. The first AP of claim 3, wherein the one or more portions of the TXOP comprise, spatial resources, time domain resources, or any combination thereof.

5. The first AP of claim 3, wherein the first AP becomes the coordinator AP in accordance with obtaining the TXOP.

6. The first AP of claim 3, wherein the first AP performs the channel access procedure or negotiates the multi-AP coordination procedure in accordance with the first AP being the coordinator AP.

7. The first AP of claim 3, wherein the one or more wireless communication devices comprise one or more stations (STAs) associated with a second AP of the co-channel collocated set of APs, and wherein the first AP communicates with the one or more STAs associated with the second AP of the co-channel collocated set of APs in accordance with the first AP being the coordinator AP.

8. The first AP of claim 2, wherein, to communicate with the one or more wireless communication devices, the processing system is configured to cause the first AP to:
transmit, within the TXOP, a packet that comprises an indication of a network allocation vector (NAV), wherein a duration of the NAV is based at least in part on a sharing of the TXOP between two or more APs of the co-channel collocated set of APs, wherein:
the duration of the NAV exclusively protects frame exchanges with the first AP based at least in part on the sharing of the TXOP between the two or more APs of the co-channel collocated set of APs, and
each AP of the co-channel collocated set of APs has prioritized channel access within the TXOP.

9. The first AP of claim 1, wherein the one or more wireless communication devices are associated with a second AP of the co-channel collocated set of APs, and wherein the cooperative wireless communication performed by the co-channel collocated set of APs comprises the first AP being able to serve wireless communication devices associated with the second AP.

10. The first AP of claim 9, wherein, to communicate with the one or more wireless communication devices, the processing system is configured to cause the first AP to:
transmit a frame that triggers at least one wireless communication device of the one or more wireless communication devices to switch from a first subchannel within an operating bandwidth to a second subchannel within the operating bandwidth.

11. The first AP of claim 9, wherein the processing system is further configured to cause the first AP to:
receive, from each wireless communication device of the one or more wireless communication devices associated with the second AP of the co-channel collocated set of APs, an indication of a capability of that wireless communication device to support being served by other APs of the co-channel collocated set of APs outside of the second AP, wherein communicating with the one or more wireless communication devices associated with the second AP is in accordance with the capability.

12. The first AP of claim 1, wherein the co-channel collocated set of APs comprises a plurality of multiple basic service set identifier (BSSID) sets, and wherein the configuration of the co-channel collocated set of APs further comprises:
a first indication of a first quantity of BSSIDs in each multiple BSSID set of the plurality of multiple BSSID sets, and
a second indication of a second quantity of BSSIDs across the plurality of multiple BSSID sets of the co-channel collocated set of APs.

13. The first AP of claim 1, wherein the co-channel collocated set of APs comprises a plurality of multiple basic service set identifier (BSSID) sets, and wherein the configuration of the co-channel collocated set of APs further comprises, for each multiple BSSID set of the plurality of multiple BSSID sets:
a first indication of a reference BSSID for that multiple BSSID set, and
a second indication of a quantity of BSSIDs in that multiple BSSID set.

14. The first AP of claim 1, wherein the co-channel collocated set of APs comprises a plurality of multiple basic service set identifier (BSSID) sets, and wherein each multiple BSSID set of the plurality of multiple BSSID sets corresponds to a different basic service set (BSS) color of a plurality of BSS colors.

15. The first AP of claim 14, wherein:
the cooperative wireless communication performed by the co-channel collocated set of APs is in accordance with an interpretation, by first wireless communication devices that have a first capability, of different BSS colors of the plurality of BSS colors as being indicative of intra-BSS communication, and
second wireless communication devices that have a second capability interpret the different BSS colors of the plurality of BSS colors as being indicative of inter-BSS communication.

16. The first AP of claim 1, wherein the co-channel collocated set of APs comprises a plurality of multiple basic service set identifier (BSSID) sets, and wherein each multiple BSSID set of the plurality of multiple BSSID sets corresponds to a same basic service set (BSS) color.

17. The first AP of claim 1, wherein the co-channel collocated set of APs comprises a plurality of multiple basic service set identifier (BSSID) sets, and wherein the cooperative wireless communication is in accordance with a disablement of a basic service set (BSS) color.

18. A method for wireless communication by a first access point (AP), comprising:
transmitting one or more frames that comprise information indicative of a configuration of a co-channel collocated set of APs, the co-channel collocated set of APs comprising the first AP, and the co-channel collocated set of APs comprising a coordinator AP that facilitates cooperative wireless communication performed by the co-channel collocated set of APs; and
communicating with one or more wireless communication devices in accordance with the configuration of the co-channel collocated set of APs.

19. The method of claim 18, wherein the coordinator AP is an AP of the co-channel collocated set of APs that obtains a transmission opportunity (TXOP) as a result of a channel access procedure, obtains a shared TXOP from a non-collocated AP, or serves a station (STA) associated with another AP of the co-channel collocated set of APs.

20. The method of claim 18, wherein the configuration of the co-channel collocated set of APs comprises an identifier of the coordinator AP that facilitates the cooperative wireless communication performed by the co-channel collocated set of APs.
